(19) United States
(12) Patent Application Publication
(10) Pub. No.: US 2020/0070489 A1
(43) Pub. Date: Mar. 5, 2020

(54) LAMINATION

(71) Applicant: Faurecia Automotive Seating, LLC, Auburn Hills, MI (US)

(72) Inventors: Marcin PAJDAK, Walbrzych (PL); Ilona MIKA, Walbrzych (PL); Herve BULLE, Hericourt (FR); Philippe CHARLES, Luxeuil-les-Bains (FR)

(21) Appl. No.: 16/447,062

(22) Filed: Jun. 20, 2019

(30) Foreign Application Priority Data
Aug. 30, 2018 (FR) 1857817

(51) Int. Cl. B32B 37/14; B32B 5/18; B32B 5/12; B32B 5/02

(52) U.S. Cl. CPC B32B 37/142; B32B 5/18; B32B 5/12; B32B 2266/0278; B32B 2250/04; B32B 2307/724; B32B 5/022

(57) ABSTRACT

A material for a component of a vehicle seat. The material includes a cover layer and a foam layer.

### PRIORITY CLAIM

This application claims priority to French Application No. 1857817, filed Aug. 30, 2018, which application is hereby incorporated in its entirety herein.

### BACKGROUND

The present disclosure relates to a lamination and particularly to a laminate material for forming a panel for a cover. More particularly, the present disclosure relates to a laminate material for a cover for a foam-in-place component for a vehicle seat.

### SUMMARY

According to the present disclosure, a laminate material includes a cover layer and a foam layer. The laminate material is adapted to form a panel of a cover for a component of a vehicle seat.

In illustrative embodiments, the laminate material includes a foam layer located between a cover layer and a gas permeable film layer, with the cover layer at least partially encapsulating the foam layer. The film layer is adapted to separate the foam layer of the laminated material from a foam core of a component of a vehicle seat.

In illustrative embodiments, the laminate material may include a gas permeable fabric layer located between the film layer and the foam layer.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a laminate material;

FIG. 2 is a sectional view taken along line 2-2 of FIG. 1 showing the various layers included in the laminate material; and

FIG. 3 is a partial perspective view of a component of a vehicle seat, with portions broken away to reveal the component is formed with panels of the laminate material and having a foam-in-place foam core.

### DETAILED DESCRIPTION

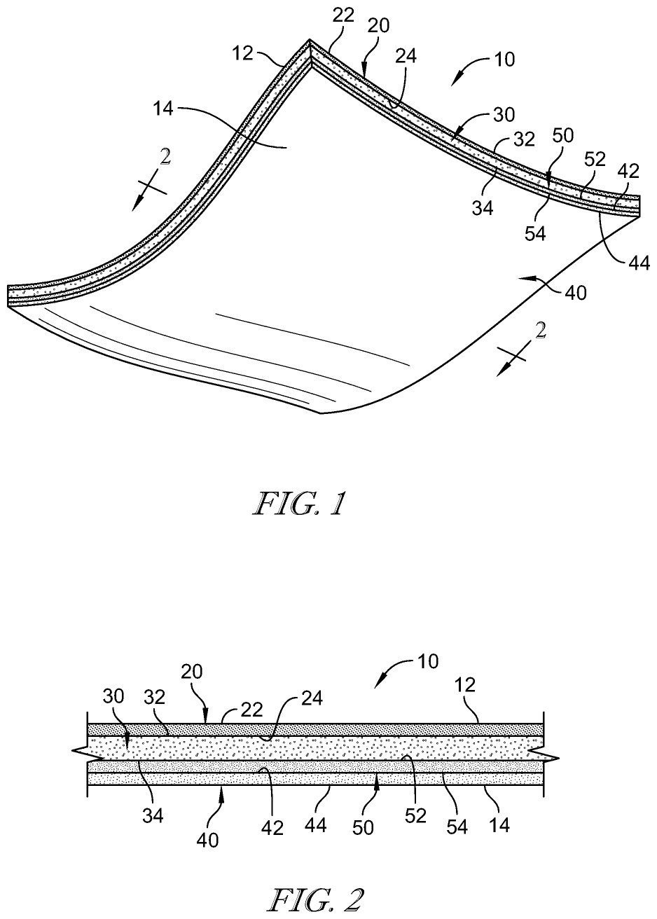

A flexible laminate material 10 includes a plurality of laminated layers formed as a sandwich as shown in FIGS. 1 and 2. Laminate material 10 includes an exterior surface 12 and a spaced apart and generally parallel interior surface 14.

Laminate material 10 includes a flexible cover layer 20 having a first surface 22 and a spaced apart and generally parallel second surface 24. First surface 22 of cover layer 20 may be generally coextensive with exterior surface 12 of laminate material 10. Cover layer 20 has a thickness that extends between first surface 22 and second surface 24. Cover layer may comprise materials such as, for example, leather, artificial leather, polyvinyl chloride material, textile, fabric materials, any other suitable material, and combinations thereof.

Laminate material 10 includes a flexible and resiliently compressible foam layer 30. Foam layer 30 includes a first surface 32 and a spaced apart and generally parallel second surface 34. Foam layer 30 has a thickness that extends between first surface 32 and second surface 34. Foam layer 30 may have a thickness, for example in exemplary embodiments, of approximately 2 to 15 millimeters (mm) or less, 2 to 10 millimeters or less, or 2 to 4 millimeters or less. Foam layer 30 may comprise, for example, a low-density polyurethane foam material. The material of foam layer 30 may have a density of approximately 27 to 45 kilograms per cubic meter (kg/m³) or less. First surface 32 of foam layer 30 is located adjacent to second surface 24 of cover layer 20. First surface 32 of foam layer 30 may be directly coupled to second surface 24 of cover layer 20 by lamination and may be coupled thereto by an adhesive.

Laminate material 10 includes a flexible film layer 40 having a first surface 42 and a spaced apart and generally parallel second surface 44. Second surface 44 may be generally coextensive with interior surface 14 of laminate material 10. Film layer 40 has a thickness that extends between first surface 42 and second surface 44. Film layer 40 may have a thickness of approximately 1 mm or less. Film layer 40 may be formed from, for example, a foil material or a plastic material. Film layer 40 is, for example, gas permeable. Film layer 40 may have a gas permeability for air of at least about 10 to 20 liters/square meter/second (l/m²/s). Foam layer 30 is located between first surface 42 of film layer 40 and second surface 24 of cover layer 20. First surface 42 of film layer 40 may be coupled directly to second surface 34 of foam layer 30 by lamination and may be coupled thereto with an adhesive. Laminate material 10 thereby comprises a sandwich material wherein foam layer 30 is sandwiched between film layer 40 and cover layer 20, with cover layer 20 at least partially encapsulating foam layer 30.

Laminate material 10 may optionally include a flexible fabric layer 50 having a first surface 52 and a spaced apart and generally parallel second surface 54. Fabric layer 50 may comprise a non-woven fabric or textile material. Fabric layer 50 is gas permeable and may have gas permeability for air of at least approximately 10 to 20 liters/square meter/second. Fabric layer 50 has thickness that extends between first surface 52 and second surface 54. Fabric layer may have a thickness of approximately 2 mm or less. Fabric layer 50 is located between film layer 40 and foam layer 30. First surface 52 of fabric layer 50 may be directly coupled to second surface 34 of foam layer 30, and second surface 54 of fabric layer 50 may be directly coupled to first surface 42 of film layer 40. Fabric layer 50 may be laminated to film layer 40 and foam layer 30 and may be coupled to film layer 40 and foam layer 30 by an adhesive. Laminate material 10 may be formed with, or without, fabric layer 50 as desired. Laminate material 10 may be formed with the fabric layer 50, such that fabric layer 50 provides additional strength and stiffness to laminate material 10 while still allowing laminate material 10 to be flexible.

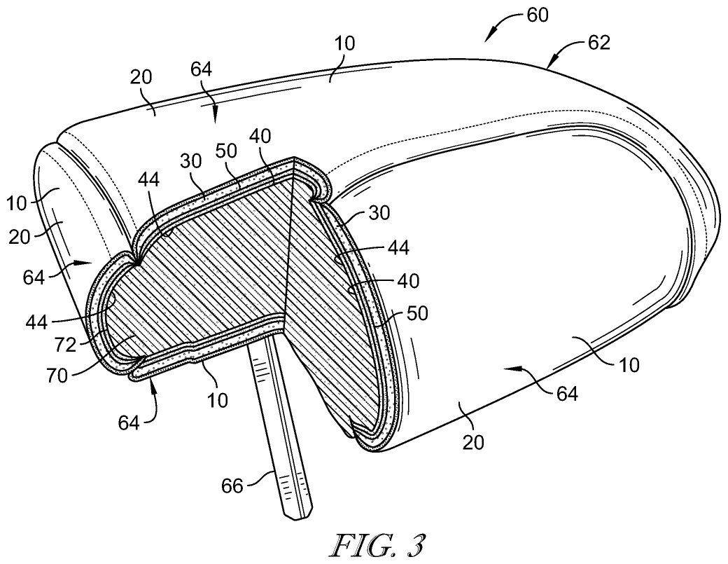

A component 60 for a vehicle seat of a vehicle, as shown in FIG. 3, includes a cover 62. Component 60, may be for example, be a head rest, armrest, back or seat component of a vehicle seat. Cover 62 includes a plurality of panels 64. Each panel 64 may be formed from laminate material 10. Component 60 may also include a mounting member 66. Adjacent edges of adjacent panels 64 may be coupled to one another by sewing or the like.

Panels 64 of cover 62 may be placed within an interior chamber of a mold with exterior surface 12 of laminate material 10 of each panel 64 in engagement with an inside surface of a wall of the mold. Foam is injected into an interior cavity formed by and within cover 62 to form a foam core 70 within cover 62. Foam core 70 includes an exterior surface 72 that is in direct engagement with, and that is coupled and adhered to, second surface 44 of film layer 40 of laminate material 10 of each panel 64. When the foam that forms foam core 70 is injected into the cavity of cover 62, the air that was within the cavity of cover 62 flows through the gas permeable film layer 40 of laminate material 10, and through the gas permeable fabric layer 50 of laminate material 10 if included in laminate material 10.

While film layer 40 allows gas, such as air, to flow from the cavity of cover 62 through film layer 40, film layer 40 blocks the foam that forms foam core 70 from coming into direct contact with foam layer 30 of laminate material 10. The blocking of the foam of the foam core 70 from contact with foam layer 30 of laminate material 10 by film layer 40 blocks or limits the foam of foam core 70 from penetrating the foam of foam layer 30 which would otherwise create a penetration layer within foam layer 30 that is thick, hard, and densified. Such a densified penetration layer increases the hardness and stiffness of the laminate material, making the material difficult to handle during manufacture of cover 62 and component 60, and increases the amount of foam required for forming foam core 70. Film layer 40 of laminate material 10 blocks or limits the formation of a hard densified penetration layer between the foam of foam core 70 and the foam of foam layer 30.

In the illustrative embodiments, the present disclosure provides a laminate material for forming panels of a cover for a component of a vehicle seat that can be filled with a foam core using a foam-in-place process without forming a hard densification layer in the foam layer of the laminate material.

1. A laminate material comprising:
a cover layer,
a foam layer, and
a film layer, the film layer being gas permeable, the foam layer located between the cover layer and the film layer,
wherein the foam layer is at least partially encapsulated by the cover layer.

2. The laminate material of claim 1, including a fabric layer located between the film layer and the foam layer.

3. The laminate material of claim 2, wherein the fabric layer comprises a non-woven textile material.

4. The laminate material of claim 2, wherein the fabric layer is gas permeable.

5. The laminate material of claim 2, wherein the fabric layer has a thickness of approximately 2 mm or less.

6. The laminate material of claim 1, wherein the foam layer comprises a low-density polyurethane foam material.

7. The laminate material of claim 6, wherein the low density polyurethane foam material has a density of approximately 45 kg/m³ or less.

8. The laminate material of claim 1, wherein the foam layer has a thickness of approximately 2 to 15 mm or less.

9. The laminate material of claim 8, wherein the foam layer has a thickness of approximately 2 to 10 mm or less.

10. The laminate material of claim 9, wherein the foam layer has a thickness of approximately 2 to 4 mm or less.

11. The laminate material of claim 1, wherein the film layer comprises a foil material.

12. The laminate material of claim 1, wherein the film layer comprises a plastic material.

13. The laminate material of claim 1, wherein the film layer has a gas permeability of at least approximately 10 liters/square meter/second.

14. The laminate material of claim 1, wherein the cover material is selected from the group of materials comprising leather, artificial leather, polyvinyl chloride material, and textile material.

15. The laminate material of claim 1, including a foam core coupled to the film layer, the film layer being located between and separating the foam core and the foam layer.
